(19) United States
(12) Patent Application Publication
(10) Pub. No.: US 2026/0154488 A1
(43) Pub. Date: Jun. 4, 2026

(54) MULTI-FACETED SITE EVALUATOR INTEGRATING USER DEFINED EVALUATION ENGINES

(71) Applicant: Wix.com Ltd., Tel Aviv (IL)

(72) Inventors: Shy FRENKEL, Yaad (IL); Roy ELBAZ, Tel Aviv (IL); Urieah Yonathan AVNI, Tel Aviv (IL); Ran AMIT, Rishon LeTsiyon (IL); Leonid ZHUK, Gedera (IL)

(21) Appl. No.: 19/454,512

(22) Filed: Jan. 21, 2026

Related U.S. Application Data
(63) Continuation of application No. 17/579,667, filed on Jan. 20, 2022.
(60) Provisional application No. 63/139,977, filed on Jan. 21, 2021.

(51) Int. Cl. G06F 40/143; G06F 40/186; G06N 5/02

(52) U.S. Cl. CPC G06F 40/143; G06F 40/186; G06N 5/027

(57) ABSTRACT

A website building system (WBS) includes at least one hardware processor and a site evaluator running on the at least one hardware processor to evaluate at least one application area of a website according to at least one user category of the WBS. The site evaluator includes at least one evaluation engine to evaluate the at least one application area according to rules and at least one of: scripts and machine learning (ML) models, a site modifier to implement at least one of automatic and manual modifications to the website according to recommendations from the at least one evaluation engine and an evaluation engine handler to enable user creation and editing of the at least one evaluation engine.

### CROSS REFERENCE TO RELATED APPLICATIONS

This application is a continuation application of U.S. patent application Ser. No. 17/579,667 filed Jan. 20, 2022, which claims priority from US provisional patent application 63/139,977, filed Jan. 21, 2021, both of which are incorporated herein by reference.

### FIELD OF THE INVENTION

The present invention relates to website building systems generally and to website evaluation in particular.

### BACKGROUND OF THE INVENTION

Website building systems (WBS) are used by both novices and professionals to create interactive websites. Existing WBSs are based on a visual editing model and most WBSs typically provide multiple templates, with a template possibly including a complete sample website, a website section, a single page or a section of a page.

WBS users (also known as designers, subscribers, subscribing users or site editors) may design the website and the website's end-users (the “users of users”) may access the websites created by the users. Although end-users typically access the system in read-only mode, WBSs (and websites) may allow end-users to perform changes to the web site such as adding or editing data records, adding talkbacks to news articles, adding blog entries to blogs etc. The WBS may in fact allow multiple levels of users (i.e., more than two levels), and assign different permissions and capabilities to each level. Users of the WBS (in particular in the full or partial on-line configurations described in more detail herein below) may register with the WBS server which manages the users, their web sites and accesses by the end-users.

A WBS may be a standalone system, or may be embedded inside a larger editing system. It may also be on-line (i.e., applications are edited and stored on a server), off-line or partially on-line (with web sites being edited locally but uploaded to a central server for publishing). The WBS may use an internal data architecture to store WBS based sites and this architecture may organize the handled sites'internal data and elements inside the system. This architecture may be different from the external view of the site (as seen, for example, by the end-users). It is also typically different from the way the HTML pages sent to the browser are organized.

For example, the internal data architecture may contain additional properties for each element in the page (creator, creation time, access permissions, link to templates, SEO (search engine optimization) related information etc.) which are relevant for the editing and maintenance of the site in the WBS, but are not externally visible to end-users (or even to some editing users). The WBS may implement some of its functionality (including both editing and run-time functionality) on a server or server set, and some of its functionality on client elements. The WBS may also determine dynamically whether to perform some functionality on the server or on the client platform.

A WBS typically handles the creation and editing of visually designed applications (such as a website) consisting of pages, containers and components. Pages may be separately displayed and contain components. Components may include containers as well as atomic components. Reference is made to FIG. 1, which is a schematic block-diagram illustration of a website building system (WBS) 2 which may be used for building a website 3, in accordance with some demonstrative embodiments of the present invention. WBS 2 may be used to build, produce, edit and/or generate website 3, which may comprise pages 4 which may include components 5 (e.g., text, images, videos).

The WBS may also support hierarchical arrangements of components using atomic components (text, image, shape, video etc.) as well as various types of container components which contain other components (e.g., regular containers, single-page containers, multi-page containers, gallery containers etc.). The sub-pages contained inside a container component are referred to as mini-pages, and each of which may contain multiple components. Some container components may display just one of the mini-pages at a time, while others may display multiple mini-pages simultaneously.

The components may be content-less, or have internal content. An example of the first category is a star-shape component, which does not have any internal content (though it has color, size, position, attributes and other parameters). An example of the second category is a text paragraph component, whose internal content includes the internal text as well as font, formatting and layout information (which is also part of the content rather than being attributes of the component). This content may, of course, vary from one instance of the text paragraph component to another. Components which have content are often referred to as fields (e.g. a “text field”).

Pages may use templates: general page templates or component templates. Specific cases for templates include the use of an application master page containing components replicated in all other regular pages, and the use of an application header or footer (which repeat on all pages). Templates may be used for the complete page or for page sections. The WBS may provide inheritance between templates, pages or components, possibly including multi-level inheritance, multiple inheritance and diamond inheritance (i.e. A inherits from B and C and both B and C inherit from D).

The visual arrangement of components inside a page is called a layout. The WBS may also support dynamic layout processing, a process whereby the editing of a given component (or other changes affecting it such as externally-driven content change) may affect other components, as further described in U.S. Pat. No. 10,185,703 entitled “Website Design System Integrating Dynamic Layout and Dynamic Content” granted 22 Jan. 2019, commonly owned by the Applicant and incorporated herein by reference.

A WBS may be extended using add-on applications such as a third party application and its components (TPAs), list applications (such as discussed in US Patent Publication No. US 2014/0282218 entitled “WBS Integrating Data Lists with Dynamic Customization and Adaptation” published 18 Sep. 2014, commonly owned by the Applicant and incorporated herein by reference) and WBS configurable applications (WCAs, such as described in US Patent Publication No. 2020/0151226 entitled “System And Method for Creation and Handling of Configurable Applications for Website Building Systems” published 14 May 2020 commonly owned by the Applicant and incorporated herein by reference). These third party applications and list applications may be added and integrated into designed websites.

Such third party applications and list applications may be purchased (or otherwise acquired) through a number of distribution mechanisms, such as being pre-included in the WBS design environment, from an Application Store (integrated into the WBS's market store or external to it) or directly from the third party application vendor.

The third party application may be hosted on the WBS vendor's own servers, the third party application vendor's server or on a 4th party server infrastructure.

The WBS may also allow procedural code to be added to some or all of the system's entities. Such code could be written in a standard language (such as JavaScript), an extended version of a standard language or a language proprietary to the specific WBS. The executed code may reference APIs provided by the WBS itself or external providers. The code may also reference internal constructs and objects of the WBS, such as pages, components and their attributes.

The procedural code elements may be activated via event triggers which may be associated with user activities (such as mouse move or click, page transition etc.), activities associated with other users (such as an underlying database or a specific database record being updated by another user), system events or other types of conditions. The use of such procedural code elements is further described in U.S. Pat. No. 10,209,966 entitled “Custom back-end functionality in an online website building environment” granted 19 Feb. 2019, commonly owned by the Applicant and incorporated herein by reference.

The activated code may be executed inside the WBS's client element, on the server platform or by using a combination of the two or a dynamically determined execution platform. Such a system is described in US Patent Publication No. US 2018/0293323 entitled “System and Method for Smart Interaction Between Website Components” published 11 Oct. 2018, commonly owned by the Applicant and incorporated herein by reference.

Typical site creation may be based on a number of models, including a visual editing model (in which the user edits a previously created site) and an automatic site generation model or a combination thereof as illustrated in FIG. 2 to which reference is now made and is described in U.S. Pat. No. 10,073,923 entitled “System and Method for the Creation and Update of Hierarchical Websites Based on Collected Business Knowledge” granted 11 Sep. 2018, commonly owned by the Applicant and incorporated herein by reference.

It will be appreciated that throughout the specification, the acronym WBS may be used to represent a website building system. FIG. 2 illustrates a system 100 that comprises a typical WBS 2 in communication with client systems operated by WBS vendor staff 61, a site designer 62 (i.e. a user), a site user 63 (i.e. user of user) and with external systems 70. WBS 2 may further comprise a WBS site manager 10, an object marketplace 15, a WBS RT (runtime) server 20, a WBS editor 30, a site generation system 40 and a WBS content management system (CMS) 50.

In the visual editing model, the user (designer) edits a site based on one or more website templates. The WBS provider may provide multiple site (or other) templates, with each template possibly including a complete sample web site, a web site section, a single page or a section of a page. Users may have the option to start with an empty site (essentially a “blank page” template) but would typically start with an actual site template.

The WBS provider may provide site templates ranging from the very generic (e.g. mobile site, e-store) through the more specific (e.g. law office, restaurant, florist) to the highly specific ones (e.g. a commercial real-estate law office or a Spanish tapas restaurant). Such templates are typically stored in a repository accessible to users of the WBS and are typically classified according to business type, sub-type or industry. Templates may also be created (and classified) according to style, color range or other parameters and not just according to business type. Site templates may be extended with additional (typically back-end) functionality, services and code in order to become full-fledged vertical solutions integrated with the WBS.

The site may be converted/rendered into HTML for viewing. However, in some embodiments, components may be implemented and/or rendered using additional technologies, such as locally installed or downloaded code, plug-ins, rendering frameworks (such as React), graphical display frameworks (such as SVG), or other methods.

Thus, the user's first experience when creating a site using a WBS visual editor may typically be that the user chooses a template (e.g. according to style or industry type / sub-type), possibly a blank template and then edits the template in the visual editor including the editing of content, logic, layout and attributes. Such editing may include (in particular) adapting the template and its elements to the details of the user's business. The user may then publish the modified site.

Under the site generation model, the WBS generates an initial site for the user, based on a selected template, possibly modified by filling-in common elements of information, and possibly allowing follow-up editing of the generated site. This filling-in is required as various pieces of information (such as the business name or a description of the management team) are included in multiple locations in the template's pages. Thus, the user may have to change the business name (for example) in multiple places throughout the template.

Furthermore, some template elements (e.g. a generic product page) may appear multiple times, with each instance displaying the details of a different instance of an underlying entity (e.g. different products offered in the site). Such multiple instances may be manually specified (e.g. the details of different persons in the company's management team) or dynamically derived from an external database (e.g. product details from the “products on sale” database). Such an arrangement is often known as a “repeater”.

The template may also include fields. For example, the WBS may allow the template designer to specify fields (also known as “placeholders”) for the insertion of values inside the templates, such as {CompanyName}, {ProductName}, {ProductPrice} etc. The user may also specify the values for the fields defined in the template selected for the website.

The WBS may allow the user to enter simple or complex values (e.g. text and images), as well as additional (non-field) information such as selection of included pages or web site areas, colors, style information, links, formatting options, website display options, decoration elements (such as borders and backgrounds) etc.

The WBS may also allow the user to enter some of this additional information before selecting a template, and use this information to help in selecting a template (e.g. by narrowing the set of proposed templates). For example, the user may select a certain generic color scheme (e.g. pastel colors) or style (e.g. business/formal), and the system may then use this selection to narrow the set of proposed templates.

The WBS may also display a series of views or questionnaires to allow the user to enter values or selections (for both the defined fields and the additional information above). The WBS may further create a connection (or binding) between a multiple-instance element of the template (as described herein above) and an internal or external database which provides the data instances used to generate the displayed instances.

Once a template has been selected and its fields and additional information have been specified (e.g. through the questionnaires or through binding to data sources), the WBS may generate the website containing the combined information. The user may then publish the site (through the WBS or otherwise).

A WBS may support SEO review for application constructed in the WBS, as discussed in US Patent Publication No. US 2019/0026280 entitled “System and method for integration of search engine optimization in website building systems” published 24 Jan. 2019, commonly owned by the Applicant and incorporated herein by reference.

A WBS may also perform semi-automatic site creation using a different model as described in U.S. Pat. No. 10,073,923. Under this model, the system gathers information on the user and his web site requirements from multiple sources which may include, for example: user-filled questionnaires; existing user presence (such as existing web sites or social media presence), industry sources (such as general trade web sites), off-line information and internal system repositories which provide information on specific business types, such as basic template information for specific business types (lawyers, restaurants, plumbers, graphic designers etc.), possibly refined for specific industries (e.g. distinguishing between real-estate lawyers and personal injury lawyers).

The WBS may also gather external information from other sites, both internal and external to the WBS. Such information may affect, for example, the selection of offered questionnaires and layout elements, proposed defaults etc. Such information may also typically be collected on a statistical or summary basis, in order not to expose information belonging to any single user, and protect users' privacy, anonymity and legal rights (such as copyrights). Such information may be located based on information provided by the user which may be direct (e.g. an existing website address) or indirect (a business name and geographical address which can be used to locate information about the business).

The gathered information is analyzed and arranged into a repository of content elements which are then mapped onto layout elements which present the content from the content elements and combine the layout elements to form the site. The layout element mapping, selection and combination process may be fully automatic or semi-automatic (i.e. including user interaction).

To support the above mentioned functionality above, a WBS may typically maintain a series of repositories, stored over one or more servers or server farms. Such repositories may typically include various related repositories such as a user information/profile repository, a WBS (WBS) component repository, a WBS site repository, a Business Intelligence (BI) repository, an editing history repository, a third party application store repository, etc. The system may also include site/content creation related repositories such as a questionnaire type repository, a content element type repository, a layout element type repository, a design kit repository, a filled questionnaires repository, a content element repository, a layout element repository, a rules repository, a family/industry repository etc. A description of these repositories may be found in U.S. Pat. No. 10,073,923.

### SUMMARY OF THE PRESENT INVENTION

There is provided, in accordance with a preferred embodiment of the present invention, a website building system (WBS), the system includes at least one hardware processor and a site evaluator running on the at least one hardware processor to evaluate at least one application area of a website according to at least one user category of the WBS. The site evaluator includes at least one evaluation engine to evaluate the at least one application area according to rules and at least one of: scripts and machine learning (ML) models; a site modifier to implement at least one of automatic and manual modifications to the website according to recommendations from the at least one evaluation engine and an evaluation engine handler to enable user creation and editing of the at least one evaluation engine.

Moreover, in accordance with a preferred embodiment of the present invention, the system also includes an evaluation engine coordinator to receive an evaluation request and to determine which at least one evaluation engine to use, a data gatherer to gather data for use by the at least one evaluation engine and a repository to store the at least one evaluation engine and its parameters.

Further, in accordance with a preferred embodiment of the present invention, the at least one evaluation engine includes a rule engine to activate the rules and at least one of: scripts and machine learning (ML) models; an evaluation analyzer to evaluate the at least one application area according to the rule engine; a results analyzer to analyze the output of the evaluation analyzer and a recommender to recommend manual and automatic modifications to the website according to the results analyzer.

Still further, in accordance with a preferred embodiment of the present invention, the site modifier includes a site editor to enable a user to make the manual modifications to the website according to the recommendations; and a site user interface (UI) creator to create UIs for the site editor according to the recommendations.

Additionally, in accordance with a preferred embodiment of the present invention, the evaluation engine handler includes an evaluation engine (EVE) creator to enable a user to create and configure an evaluation engine; and an evaluation engine (EVE) editor to enable a user to edit and update the evaluation engine.

Moreover, in accordance with a preferred embodiment of the present invention, the evaluation engine handler includes an evaluation engine (EVE) user interface (UI) creator to create at least one user interface for the EVE creator and the EVE engine.

Further, in accordance with a preferred embodiment of the present invention evaluation, the data gatherer includes a WBS data gatherer to gather at least one of templates, third party application internal material and installed vertical and vertical applications for the website when the website is built using the WBS; an internal data gatherer to integrate information from other sources external to the website within the WBS; and an external data gatherer to access and integrate information for the website from sources external to the WBS.

Still further, in accordance with a preferred embodiment of the present invention, the evaluation analyzer includes at least one of: a WBS object analyzer to analyze the component architecture of the website when the website is built using the WBS; an HTML site analyzer to analyze the structure and layout of the website together with semantic and behavioral relationships between components when the website is built using the WBS; a foreign WBS analyzer to analyze the component architecture of websites not built by the WBS; a machine learning (ML) model trainer to train machine learning models for the at least one application area and to develop ML based evaluation engines for use with the site evaluator; a BE (back-end) element analyzer to analyze back-end elements of the website; a code analyzer to analyze code embedded in the website; a vertical application analyzer to analyze the performance of the integration and use of vertical applications within the website; a third party application (TPA)/configurable WBS application (WCS) analyzer to analyze interfaces with associated third party applications and configurable WBS applications to the website; a user profile analyzer to determine the least one user category; an editing history analyzer to analyze stored editing history of the website when built by the WBS; a business intelligence (BI) analyzer to analyze associated business information for the website and a multiple site integrator to review multiple sites and to detect common style and design elements across the multiple sites.

Additionally, in accordance with a preferred embodiment of the present invention, the at least one application area is at least one of: quality, accessibility, correctness, SEO, compliance, performance, consistency and readiness for deployment.

Moreover, in accordance with a preferred embodiment of the present invention, the at least one user category is at least one of: WBS vendor staff, WBS vendor developers, internal studio and customer support/care staff, accessibility (Ally) reviewers, agencies handling client sites, website building and WBS consultants and general WBS users and designers.

Further, in accordance with a preferred embodiment of the present invention, the at least one evaluation engine evaluates the at least one application area of the website over at least one of: different platforms and responsive design alternatives.

There is provided, in accordance with a preferred embodiment of the present invention, a method for a website building system (WBS), the method includes using at least one evaluation to evaluate at least one application area of a website according to at least one user category of the WBS according to rules and at least one of: scripts and machine learning (ML) models, implementing at least one of automatic and manual modifications to the website according to recommendations from the at least one evaluation engine for the at least one application area; and enabling user creation and editing of the at least one evaluation engine.

Moreover, in accordance with a preferred embodiment of the present invention, the method also comprises receiving an evaluation request and determining which at least one evaluation engine to use; gathering data for use by the at least one evaluation engine; and storing in a repository the at least one evaluation engine and its parameters.

Further, in accordance with a preferred embodiment of the present invention, the using at least one evaluation engine to evaluate includes activating the rules and at least one of: scripts and machine learning (ML) models, evaluating the at least one application area according to the activating the rules; analyzing the output of the evaluating the at least one application area; and recommending manual and automatic modifications to the website according to the analyzing the output.

Still further, in accordance with a preferred embodiment of the present invention, the implementing at least one of automatic and manual modifications includes enabling a user to make the manual modifications to the website according to the recommendations; and creating at least one user interface for the enabling a user to make the manual modifications according to the recommendations.

Additionally, in accordance with a preferred embodiment of the present invention, the enabling user creation and editing includes enabling a user to create and configure an evaluation engine; and enabling a user to edit and update the evaluation engine.

Moreover, in accordance with a preferred embodiment of the present invention, the enabling user creation and editing also includes creating user interfaces for the enabling a user to create and configure and the enabling a user to edit and update.

Further, in accordance with a preferred embodiment of the present invention, the gathering data includes gathering at least one of templates, third party application internal material and installed vertical and vertical applications for the website when the website is built using the WBS; integrating information from other sources external to the website within the WBS; and accessing and integrating information for the website from sources external to the WBS.

Still further, in accordance with a preferred embodiment of the present invention, the evaluating the at least one application area according to activating the rules includes at least one of: analyzing the component architecture of the website when the website is built using the WBS; analyzing the structure and layout of the website together with semantic and behavioral relationships between components when the website is built using the WBS; analyzing the component architecture of websites not built by the WBS; training machine learning models for the at least one application area and developing machine learning based evaluation engines; analyzing back-end elements of the website; analyzing code embedded in the website; analyzing the performance of the integration and use of vertical applications within the website; analyzing interfaces with associated third party applications and configurable WBS applications to the website; determining the least one user category; analyzing stored editing history of the website when built by the WBS; analyzing associated business information for the website; and reviewing multiple sites and detecting common style and design elements across the multiple sites.

Additionally, in accordance with a preferred embodiment of the present invention, at least one application area is at least one of: quality, accessibility, correctness, SEO, compliance, performance, consistency and readiness for deployment.

Moreover, in accordance with a preferred embodiment of the present invention, the least one user category is at least one of: WBS vendor staff, WBS vendor developers, internal studio and customer support/care staff, accessibility (Ally) reviewers, agencies handling client sites, web site building and WBS consultants and general WBS users and designers.

Further, in accordance with a preferred embodiment of the present invention, the at least one evaluation engine evaluates the at least one application area of the website over at least one of: different platforms and responsive design alternatives.

There is provided, in accordance with a preferred embodiment of the present invention, a site evaluator integrated with a website building system (WBS), the site evaluator includes at least one evaluation engine to evaluate at least one application area of a website according to rules and at least one of: scripts and machine learning (ML) models and at least one user category of the WBS; a data gatherer to gather data internal and external to the WBS for use by the at least one evaluation engine; and a site modifier to provide manual and automatic modifications to the website according to recommendations from the at least one evaluation engine.

There is provided, in accordance with a preferred embodiment of the present invention, a method for a website building system (WBS), the method includes evaluating at least one application area of a website according to rules and at least one of scripts and machine learning (ML) models and at least one user category of the WBS; gathering data internal and external to the WBS for use by the evaluating at least one application area; and providing manual and automatic modifications to the website according to recommendations from the evaluating at least one application area.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a typical representation of a website building system of the prior art;

FIG. 2 is a schematic illustration of a system for the creation and update of hierarchical websites.

FIG. 3 is a schematic illustration of a system of a multifaceted evaluation system for a website building system, constructed and operative in accordance with the present invention;

FIG. 4 is a schematic illustration of the site evaluator of FIG. 3, constructed and operative in accordance with the present invention;

FIG. 5 is a schematic illustration of the evaluation engine handler of FIG. 4, constructed and operative in accordance with the present invention;

FIG. 6 is a schematic illustration of the data gatherer of FIG. 4, constructed and operative in accordance with the present invention;

FIG. 7 is a schematic illustration of an evaluation engine of FIG. 4, constructed and operative in accordance with the present invention;

FIG. 8 is a schematic illustration of the evaluation analyzer of FIG. 7, constructed and operative in accordance with the present invention;

FIGS. 9A-9F are schematic illustrations of different evaluation engines 82 that may be invoked for different areas of application and rules that may apply, constructed and operative in accordance with the present invention; and

FIG. 10 is a schematic illustration of the relationships between application areas and evaluation engines, constructed and operative in accordance with the present invention.

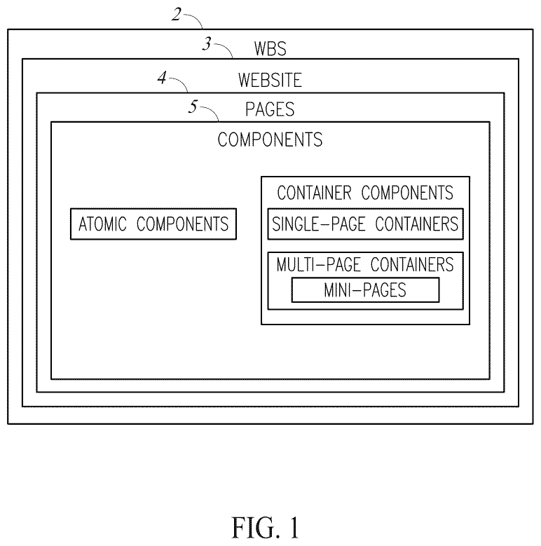

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that as websites become more and more complex, tools are needed to evaluate them (in terms of content, structure, layout, interactions, searchability etc.) typically during the creation and maintenance stages from multiple facets/application areas and by multiple user classes or categories. Applicant has further realized that that different evaluation methodologies may be required for different types of websites and application areas. Existing testing and evaluation systems are typically aimed at a specific single type of evaluation or application area (such as SEO optimization or an accessibility evaluation).

The existing evaluation systems of the prior art are typically targeted for use by site designers only, and include a pre-defined set of rules aimed at the specific evaluation type or area.

Furthermore, many such existing systems typically require a specific baseline to be defined. Thus, in order to fully evaluate a web site, the WBS user or site designer is required to provide information about the expected results together with the baseline for testing such as how a correct site should look (in terms of content, structure, layout, interactions etc.).

Applicants have realized that in order to ensure a full evaluation of a website, an evaluation system is required which can provide a unified technology for a multi-faceted evaluation of websites taking into account application areas such as quality, accessibility, correctness, SEO, compliance, consistency, readiness for deployment and more (as described in more detail herein below).

The multi-faceted evaluation system should also be able to support the needs of multiple classes of users involved in creating and deploying websites. Such users may have different requirements from the website and may have their own specific criteria and rules for site evaluation.

Applicant has also realized that the evaluation system could be integrated with a WBS in order to benefit from its functionality and stored data and should therefore support a bi-directional flow of information between the evaluation system and the integrating WBS. The following description below generally describes a WBS-integrated embodiment, though the evaluation system described may be used in a standalone embodiment as well.

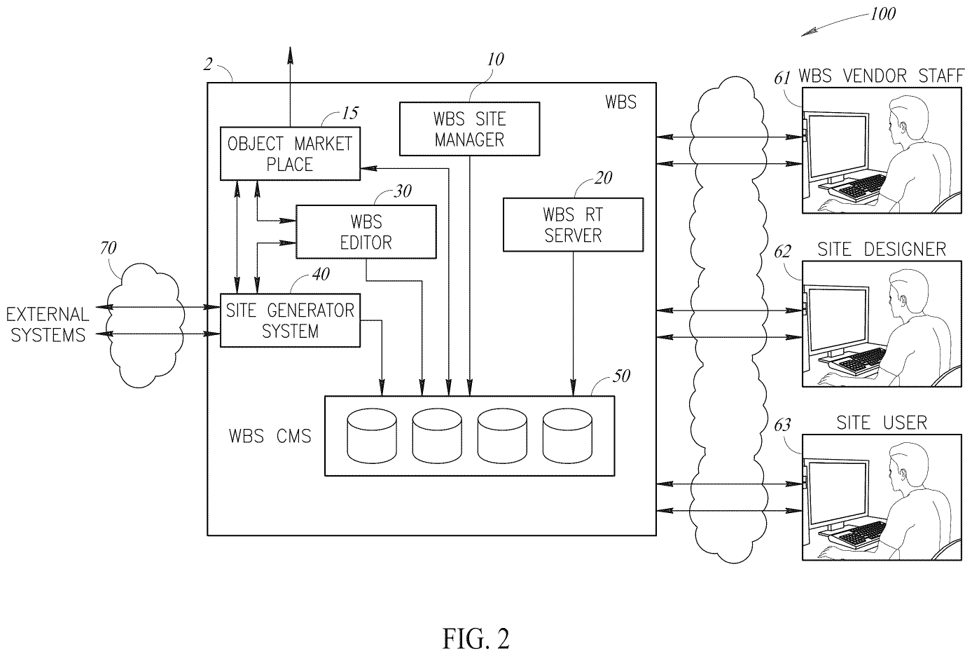

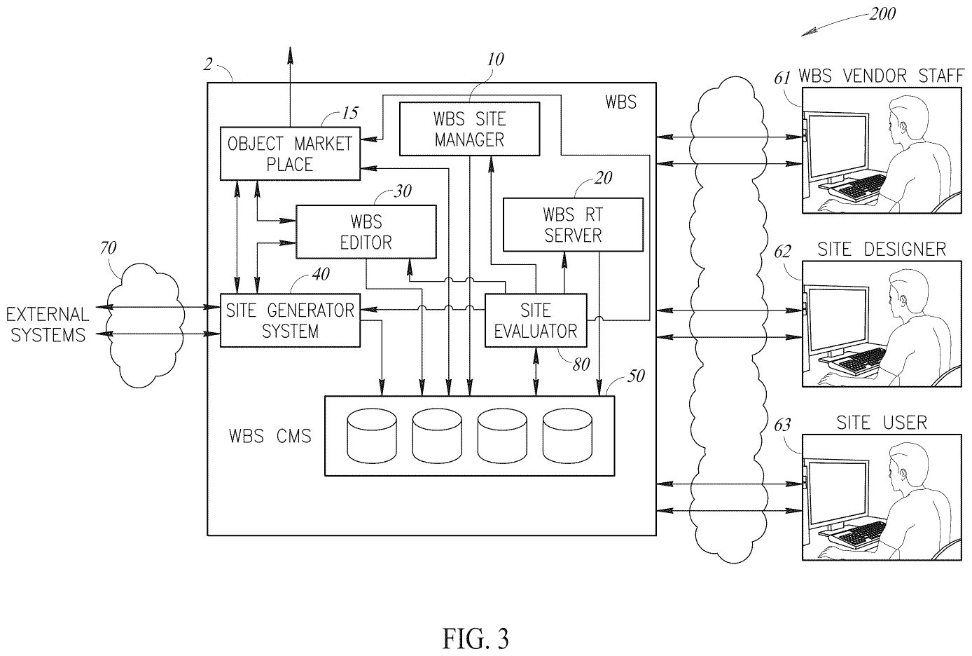

Reference is now made to FIG. 3 which illustrates a multifaceted evaluation system 200 for a website building system (WBS) 2 according to an embodiment of the present invention. System 200 may comprise a site evaluator 80 in communication with the elements of system 100 as illustrated in FIG. 2 back to which reference is now made.

As discussed herein above, WBS 2 may implement some of its functionality (including both editing and run-time functionality) on a server or server set, and some of its functionality on client elements. WBS 2 may also determine dynamically whether to perform some functionality on the server or on the client platform.

It will be appreciated that system 200 may not typically require a baseline definition, or previous knowledge of the site to be evaluated. Rather, it can handle sites it has not encountered before.

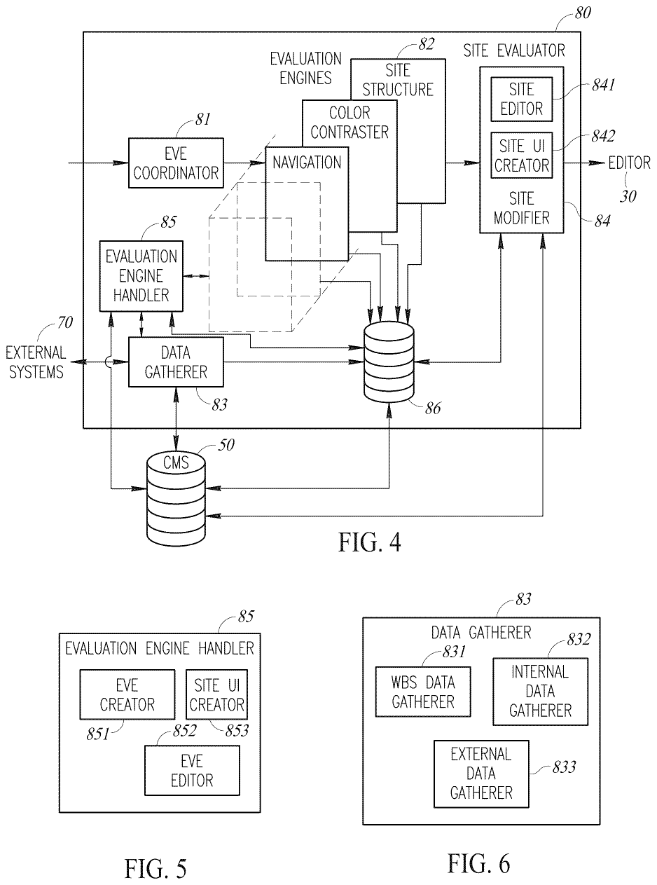

Reference is now made to FIG. 4 which illustrates the elements of site evaluator 80. Site evaluator 80 may comprise an evaluation coordinator 81, multiple evaluation engines (EVE) 82, a data gatherer 83, a site modifier 84 and an evaluation engine handler 85. In some embodiments it may also comprise an EVE repository 86. Data gatherer 83 may retrieve WBS related data from CMS 50 and from external systems 70 as described in more detail herein below.

As discussed herein above, system 200 may support multiple user categories and multiple application areas (such as but not limited to site structure, color contrast and navigation as illustrated), which may require the use of different evaluation engines 82 or sets of evaluation engines 82.

The user categories may include (but not be limited to): WBS vendor staff including WBS developers, internal studio and customer support/care staff, accessibility (Ally) reviewers, agencies (for use with client sites), experts which provide web site building and WBS consulting and general WBS users and designers. It will be appreciated that additional user categories may have their own specific requirement. For example, a large-scale distributor may have multiple clients, and may have its own internal or regulatory requirements.

Evaluation coordinator 81 may receive an evaluation request and determine which evaluation engine(s) 82 to use. Each evaluation engine 82 may evaluate different facets/application areas and/or user types or classes according to instructions from evaluation coordinator 81 and data gathered by data gatherer 83. Site modifier 84 may mark any actual modifications required from the output of evaluation engines 82 as described in more detail herein below. Site modifier 84 may comprise a site editor 841 to allow a user to edit the pertinent website based on recommendations made by evaluation engines 82 such as the handling of corrective actions and a site UI creator 842 to dynamically create interfaces for site editor 841 as described in more detail herein below. In an alternative embodiment, site editor 841 and site UI creator 842 may work with WBS editor 30 to provide a modified display of the page to be edited which highlights or otherwise supports editing and provides user feedback on site elements located by evaluation engines 82. Such WBS editor 30 support may involve modifying the elements, highlighting them (e.g., via an enclosing frame, pattern or animation), adding an element-specific UI to these elements or to the general WBS editor 30 UI, changing focus, position or zoom to these elements or other methods.

Evaluation coordinator 81 may apply a single evaluation engine 82 or a set of evaluation engines 82 for different application areas based on presets (as defined herein below) or on explicit selections by the user of which evaluation engines 82 to activate.

It will be appreciated that evaluation coordinator 81 may associate different evaluation engines 82 with the evaluation of different system elements such as components, templates, vertical applications, web site type information, user profile parameters (type, geography, experience, . . . ), user BI (business information) and editing history.

Evaluation coordinator 81 may also define (and store) priority and interference rules which control which evaluation engines 82 should be activated. Such rules may control which evaluation engines 82 should be activated, and in what order. It will be appreciated that in some embodiments, evaluation engines 82 may also be activated in parallel or cooperatively and not just in sequence.

Evaluation engine handler 85 may provide an evaluation engine development framework for creating and editing evaluation engines 82.

Reference is now made to FIG. 5 which illustrates the elements of evaluation engine handler 85. Evaluation engine handler 85 may further comprise an EVE creator 851, an EVE editor 852 and a UI creator 853. EVE creator 851 may allow users to create and configure their own evaluation engines 82 and the rules/scripts/models driving them. EVE editor 852 may allow for editing and further updates of the created evaluation engines 82 (i.e., rules, parameters etc.). UI creator 853 may provide dynamically generated interfaces for use by EVE creator 851 and EVE editor 852 as described in more detail herein below.

It will be appreciated that the WBS-based website development and deployment environment is a complex one, with multiple cooperating components and parties. The creation of a website may involve the cooperation and work of multiple parties and elements such as: the WBS produced by the WBS vendor, templates (for websites, sections and components) produced by the WBS vendor staff or by external providers and third-party applications for use with the WBS. It also may involve the actual websites, which may be produced by the site owner, a separate freelance designer or a design agency (which handles multiple client websites), end-users of the web site, which may also generate or edit content, such as user-generated content or talkbacks to a blog post and additional partners may be involved in the process. An example would be a partner providing a large-scale framework (such as a yellow-pages provider) which would provide its clients with an integrated WBS as a service.

It will also be appreciated that site evaluator 80 is aimed at evaluating sites built using a WBS and is therefore integrated with the underlying WBS. However, as discussed in more detail herein below, in an alternative embodiment, site evaluator 80 may support an analysis of non-WBS sites or of sites built using “foreign” WBS's, i.e., WBS's other than the one with which site evaluator 80 is integrated.

Site evaluator 80 may have access to WBS 2 internal data from CMS 50 and evaluation engines 82 may use this data for analysis (e.g., processing detailed component definitions instead of or in conjunction with analyzing the final generated HTML to detect the types of underlying objects). Evaluation engines 82 may also save definitions of analysis results (e.g., tasks for the site designer) together with the site in CMS 50. This saving could allow (for example) multiple designers handling the site to share the analysis results or work together to resolve located issues. The functionality of evaluation engines 82 is described in more detail herein below.

It will be appreciated that site evaluator 80 may store the various elements required for site evaluations (such as evaluation engines 82 and their parameters) in EVE repository 86. In an alternative embodiment, EVE repository 86 may be integrated with the underlying database of WBS 2 (i.e., CMS 50).

As discussed herein above, system 200 may handle multiple types or application areas of evaluation. Examples of these include (but are not limited to): accessibility (also known as “ally”, is the site accessible to everyone, including people with disabilities?), SEO (search engine optimization), security (how safe is the site safe from illegal access or other forms of hacking?) and performance (how quickly the site responds). Performance may also include the evaluation of page loading metrics such as “time to visible” and “time to interactive”, as well as more complex performance evaluations, such as these related to back-end functionality (e.g., underlying database information retrieval speed). This metric may also include information from external sources (e.g., external tools that monitor the website performance).

Other application areas may include resource use (the evaluation of the use of resources, such as memory, database connection, etc.) vertical application integration and readiness of site for release. The WBS may provide vertical applications that are used as a foundation or sub-element of web sites.

Another application area may be readiness. This may be readiness of the site for release. It may check for any material left over from the templates and the component creation (such as text objects created with “Lorem Ipsum” or “this is a title” content, or other template content, including non-text content).

It will be appreciated that WBS 2 may provide support for this function by specifically marking such content with readiness indications such as “must replace” for dummy content not suitable for a final version, “better to replace” for generic template content which is preferable to replace and “pay for use”, e.g., copyrighted content which may be used freely during the website development stage, but requires a specific engagement if used in the deployed site. This may also apply to non-displayable site elements, including back-end elements. An example would be use of demo mode access credentials for a web service, which should be replaced with deployment credentials.

Further facet evaluations may also include WBS QA (quality assurance evaluation results for use by the WBS vendor staff), versioning (issues related to the use of different versions of components and elements (such as interface compatibility issues or warning about site element versions that are going to be retired), consistency (between elements of a single site as well as between elements of different sites (e.g., multiple sites of the same organization or agency) and compliance (such as compliance with standards, laws, rules, regulations, licenses and other legal obligations (beside ally as discussed herein above). This may include compliance with obligation and rules which are organization-specific.

Site evaluator 80 may also handle the evaluation of internationalization and additional analysis or requirements which may be defined by the various system users or developer classes discussed herein above.

It will be appreciated that each evaluation engine 82 may access information collected via data gatherer 83 from other sites both within WBS 2 and external to WBS 2 subject to requirements for anonymity, privacy and site owner rights as well as all relevant laws and regulations. This can be used for comparison with the current site. Reference is now made to FIG. 6 which illustrates the sub elements of data gatherer 83. Data gatherer may further comprise a WBS data gatherer 831, an internal data gatherer 832 and an external data gatherer 833. The functionality of these elements is described in more detail herein below.

Data gatherer 83 in general may collect site pages and components, including visible and non-visible elements site elements internally and externally to WBS 2. These also may include conditionally visible elements, such as pop-up, alternative versions of pages and components, etc.

In particular, evaluation engines 82 may analyze different versions and variants of the site displayed based on platform (e.g., desktop vs. mobile) or responsive design alternatives (i.e., multiple designs based selected on display width or other parameters as described in U.S. Pat. No. 10,984,177 entitled “System and method providing responsive editing and viewing, integrating hierarchical fluid components and dynamic layout” granted 20 Apr. 2021, commonly owned by the Applicant and incorporated herein by reference).

It will be appreciated that such versions may be distinct (i.e., the responsive site versions are displayed with different width breakpoint ranges) or form a spectrum or a range (e.g., the continuum of site versions and layouts produced for a range of widths within a single breakpoint range).

Site pages and components may also include non-visible component attributes (such as checking meta-data, keywords or alt-text, which are not visible in the regular display) and backend elements which not visible from the front end directly. For example, a payment component may have a front-end part (the payment UI) and a backend part (processing the payments). Site evaluator 80 may be integrated or otherwise communicate with such a backend component.

It will be appreciated that site pages and components may further include elements using non-client rendering (such as server side rendering, and divided rendering), versions of elements (i.e., for components which can be displayed in multiple versions, checking information in all versions of the components), hidden element data (such as content of large gallery or repeater which are not visible on the screen) and versions of the site (including different layouts / components in a mobile vs. desktop version, or in different breakpoint ranges under responsive design as discussed herein above).

WBS data gatherer 831 may gather templates used by the sites of WBS 2, installed third party applications and WBS configurable applications including third party application internal material (on the 3^{rd} party server) accessed through a specific API/Web service and installed verticals and vertical applications.

Internal data gatherer 832 may integrate information from other sources external to the evaluated site such as user profile information (including geography), site business or other information (e.g., as provided by the user profile provided for site generation system 40), underlying databases storing data pertinent to a site such as an e-store catalog, list of employees etc., other sites belonging to the same organization (e.g., to check consistency between the multiple such sites), other WBS sites (subject to the site owners'anonymity, privacy and site owner rights) and external web sites (both those built using “foreign” WBSs and “built by hand” sites.

It will be appreciated that while evaluation engines 82 may make use of the extensive information provided by WBS 2, it may also make use of “external” sites that are not created on or hosted by WBS 2. Such external sites could have been created in a number of ways, such as by using a different system that is not integrated with WBS 2 or by using a different system that emits code directly executable by the browser (e.g., HTML, CSS and JavaScript code). This could be a system that emits such code or an editor that allows the user to edit such code directly (such as Dream Weaver CC™ by Adobe or Notepad++ with HTML support).

External sites may also be created using a framework (such as React by Facebook, Inc.) that allows the creation of web sites using a model different from the regular HTML/CSS/JS model. Such a framework may provide its own component architecture. External sites may also be created using pre-installed or downloaded code that executes parts of the site. This could be, for example, an integrated applet (such as Java-based applets) which implements parts of the site, a full site interactive application (including mobile apps), or a virtual-machine based component. Such code may also include native code, JIT-compiled code, interpreted code, or code using other execution methods.

External data gatherer 833 may access this information and (possibly) some of the underlying object architecture of such an external site through the following methods (for example) as implemented by a site access manager: by reading the site code (HTML/CSS/JS or otherwise) directly from the hosting server, by reading auxiliary files (such as the robots. txt file read by search engine spiders), by accessing the site through an API or a web service providing access to the stored pages, by accessing an external (non-integrated) WBS through an API or web services it provides or by accessing the traffic used to carry the evaluated web site. This could be though passive listening to (and analysis/decoding of) network communication, or through an agent embedded on the server, the client, a middleman machine (such as a carrying content delivery network such as Cloudflare) or an added “agent in the middle” which analyzed the relevant communication.

External data gatherer 833 may also use a specific browser (headless or not) which “runs” the target website and can intercept its (internal) object model or the rendered code. This can also be an extension or a plug-in to an existing browser. External data gatherer 833 may also add a client-side agent embedded together with the site code and interacts with its object model or rendering process. Alternatively, such an agent could interact with other system elements (such as the browser or the underlying operating system).

External data gatherer 833 may also access information by adding code or hardware which can track the visual display generated by the site or read the HTML or browser object model (e.g., the DOM model). It will be appreciated that in this scenario, an embodiment of system 200 may operate based on analysis of the HTML, the browser object model, or both using an evaluation engine 82 as described in more detail herein below. However, evaluation engines 82 may also perform a preliminary analysis of the gathered information to extract a higher-level model of the site elements and structure. Such a model may include aspects that are structural (i.e., what the site consists of), layout related, semantic, and behavioral. In particular, the extracted model may include not just static information (e.g., the site structure at a given time) but also dynamic information (the dynamic behavior of the site for various responses).

As discussed herein above, the actual site evaluation and testing may be performed by a set of evaluation engines 82 and different sets of evaluation engines 82 may be applied to different application areas as discussed herein above. Evaluation engines 82 may process the information as gathered by data gatherer 83 (as described herein above) and may use parameters such as rules, scripts or machine learning (ML) models to define the way the gathered information is handled.

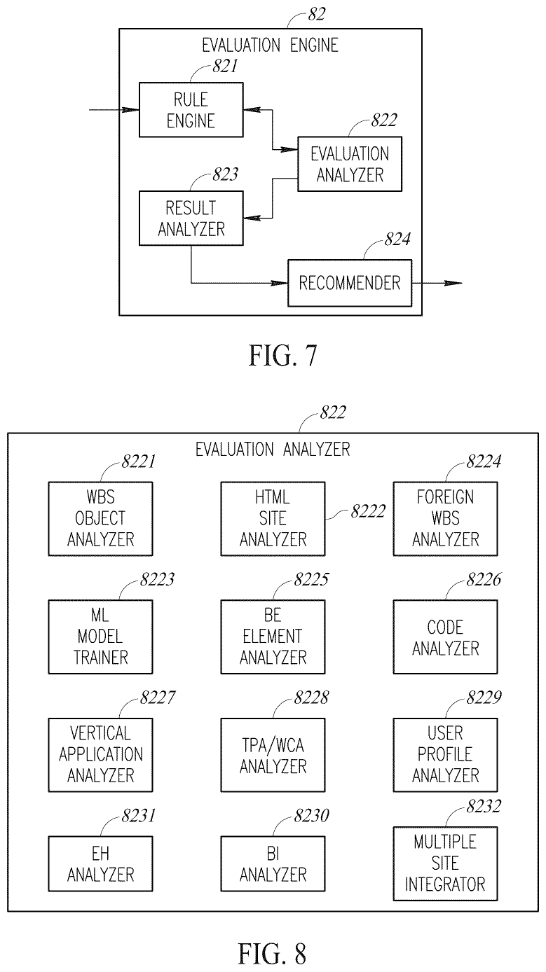

Reference is now made to FIG. 7 which illustrates the elements of an evaluation engine 82. Evaluation engine 82 may comprise a rule engine 821, an evaluation analyzer 822, a results analyzer 823 and a recommender 824.The functioning of these elements is described in more detail herein below.

Reference is now made to FIG. 8 which illustrates the elements of evaluation analyzer 822. Evaluation analyzer 822 may further comprise a WBS object analyzer 8221, an HTML site analyzer 8222, an ML (machine learning) model trainer 8223, a foreign WBS site analyzer 8224, a back end (BE) element analyzer 8225, a code analyzer 8226, a vertical application analyzer 8227, a third-party /plication/ WBS configurable applications (TPA/WCA) analyzer 8228, a user profile analyzer 8229, a business intelligence (BI) analyzer 8230, a editing history (EH) analyzer 8231 and a multiple site integrator 8232.

Rule engine 821 may provide presets, sets of predefined rules or rule selections. The available options may depend on user type, e.g., a specific preset for professional designers or for corporate IT department (which evaluates web sites developed for internal corporate use).

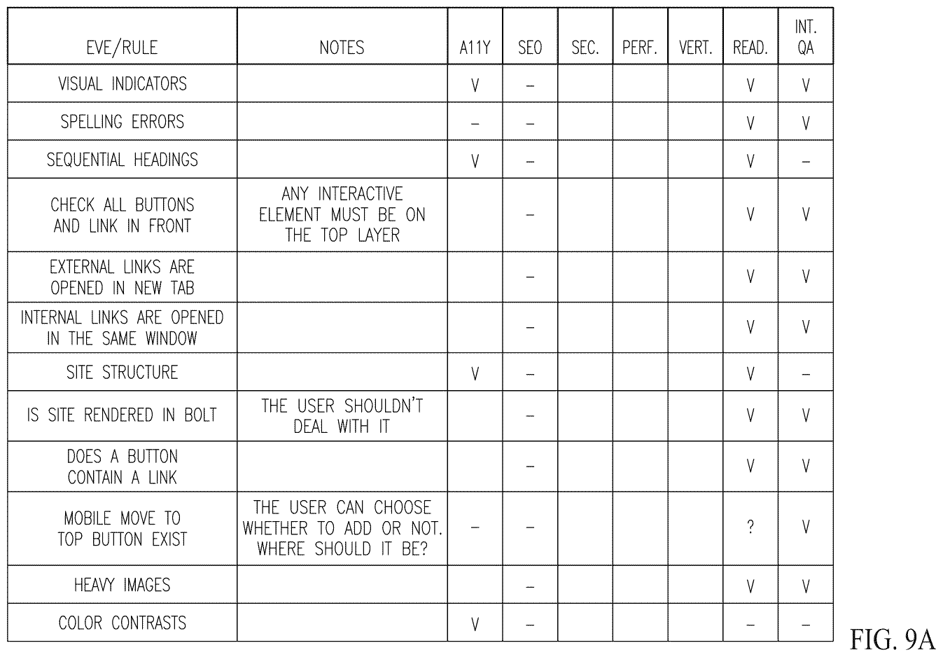

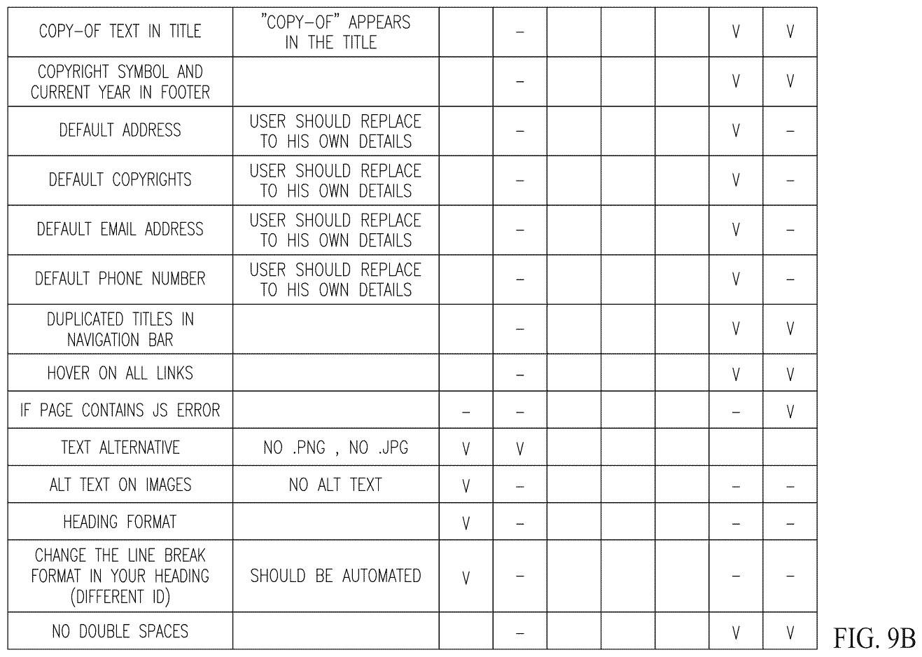

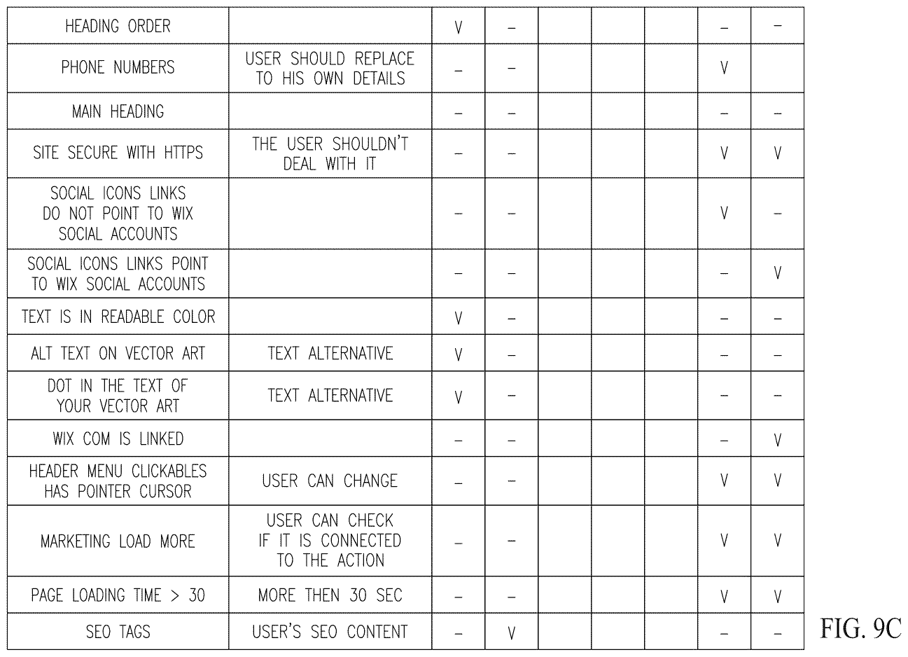

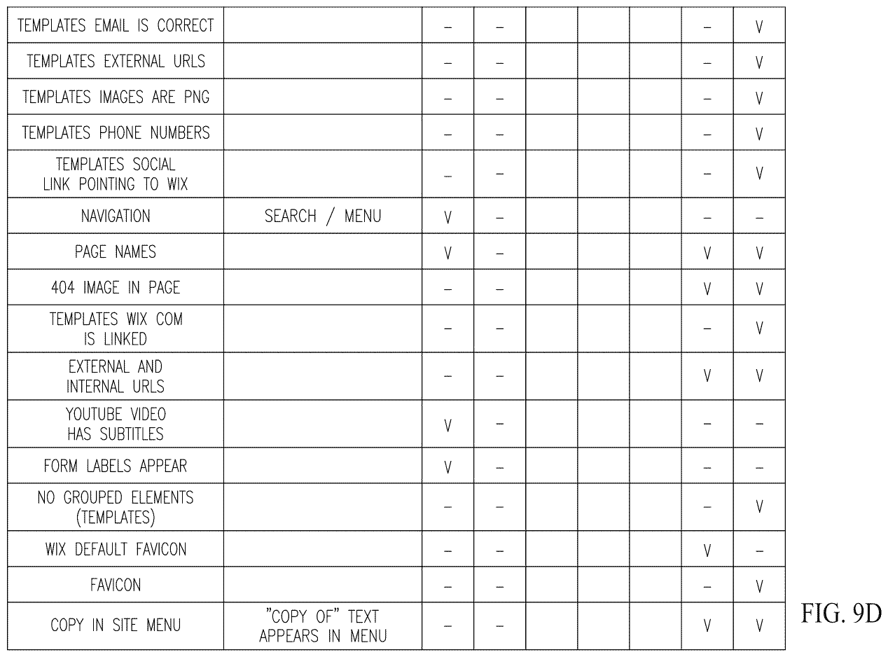

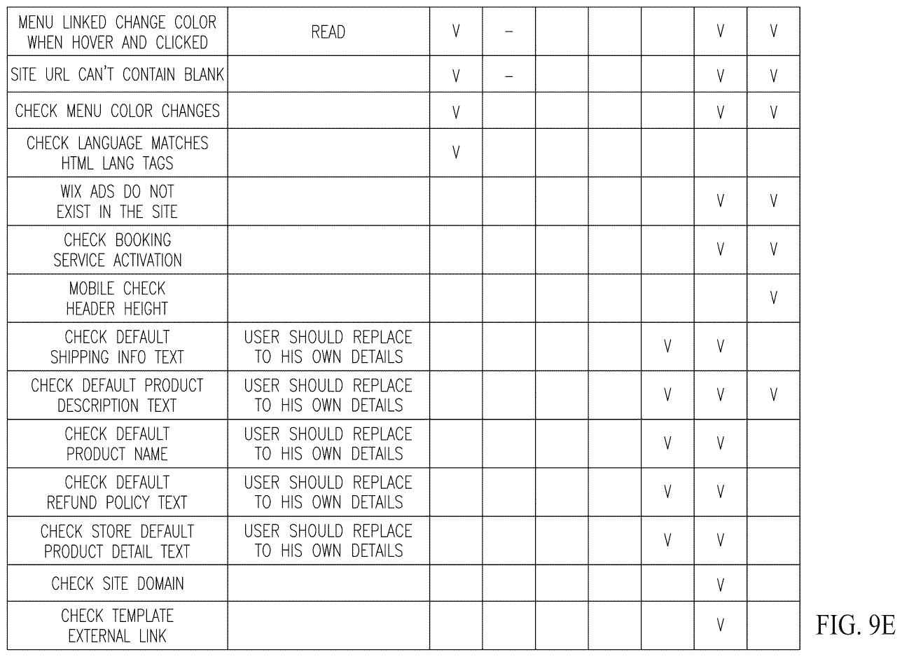

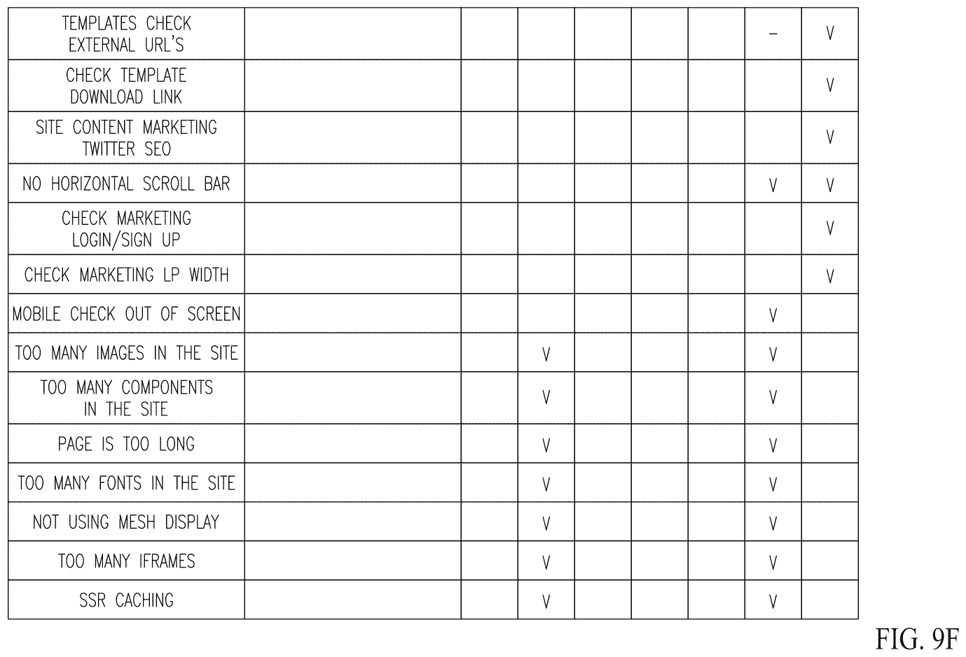

Reference is now made to FIGS. 9A-F which illustrate how different evaluation engines 82 may be invoked for different areas of application and examples of rules that may apply. For the sake of illustration, the areas of application as represented by the right-hand columns are accessibility (Ally), SEO, security, performance, vertical application integration level, readiness for publishing and internal QA issues (for WBS vendor use). As is shown, each application area may invoke more than one evaluation engine 82 and a single evaluation engine 82 may be applied to multiple application areas.

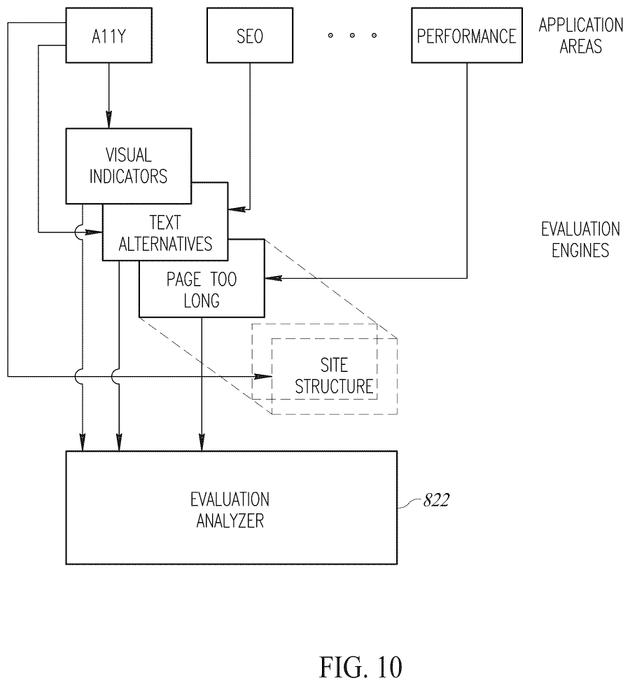

Reference is now made to FIG. 10 which illustrates how different evaluation areas may require at least one evaluation engine 82 and how each evaluation engine 82 may invoke a single or multiple analyzers from evaluation analyzer 822.

As an example, the “color contrast” evaluation engine as illustrated in FIG. 9 may have a set of multiple rules such as “can't have titles with clashing colors (red next to blue)” and “can't have text whose color is too close to the color of the background”. In this scenario, color contrast evaluation engine 82 may instruct WBS object analyzer 8221 to determine component position and color.

It will be appreciated that evaluation analyzer 822 may perform the preliminary analysis and the evaluation for the pertinent evaluation engine 82 using tools as described herein below such as data-based rules, specific analysis scripts, and ML (machine learning) models.

It will also be appreciated that for sites created using non-integrated WBSs, the specific rules, scripts, and ML models may be adapted to specific WBSs. Thus, if a site, for example, is recognized as being built by a specific external WBS (such as WordPress), evaluation engines 82 may adapt its evaluation analyzer 822 to take into account the specific elements of WordPress, such as its specific plug-in architecture.

Based on this preliminary analysis, evaluation analyzer 822 may reconstruct the actual component structure of the underlying external WBS or framework (if such one was used) and use it to apply evaluation engines 82 and rules which are defined at the recognized component level rather that at the base HTML level.

WBS object analyzer 8221 may analyze the component architecture of the site (browser object model) and process detailed component definitions instead of or in conjunction with an analysis the final generated HTML to detect the types of underlying objects on a site.

WBS object analyzer 8221 may also model and detect the use of a complex gallery in the external WBS generated site (e.g., by recognizing specific generated HTML/CSS/JS) and reconstruct such gallery from its rendered sub-components. For sites analyzed based on tracking the generated visual display as noted above, WBS object analyzer 8221 may perform the analysis on the screen image level rather than the HTML or browser object model level.

HTML site analyzer 8222 may analyze the structure and layout of the evaluated site together with semantic and behavioral relationships between components. It may use methods similar to the preprocessor as described in U.S. Pat. No. 10,176, 154 entitled “System and Method for Automated Conversion of Interactive Sites and Applications to Support Mobile and Other Display Environments” granted 8 Jan. 2019, commonly owned by the Applicant and incorporated herein by reference.

As discussed herein below, evaluation engines 82 may also use machine learning models. In this scenario, evaluation engines 82 may re-train the models on previous evaluated sites, so to adapt them (for example) to changes for WBS 2.

ML model trainer 8223 may train different machine learning models for different needs and different ML-based evaluation engines 82. ML model trainer 8223 may generate new models (based on gathered training data) and may evaluate their performance against the existing models, as discussed in more detail herein below. Training data may include any of the gathered information as gathered by data gatherer 83, as well as information on the changes performed based on the various recommendations and suggested corrective action by results analyzer 827 and recommender 828.

It will be appreciated that the machine learning models may be any suitable model for the task or activity implemented by each ML based evaluation engine 82. Machine learning models are known in the art and are typically some form of neural network. The term refers to the ability of systems to recognize patterns on the basis of existing algorithms and data sets to provide solution concepts. The more they are trained, the greater knowledge they develop.

The underlying ML models may be learning models (supervised or unsupervised). As examples, such algorithms may be prediction (e.g., linear regression) algorithms, classification (e.g., decision trees, k-nearest neighbors) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g. FCN, PSPNet, U-Net) sequence to sequence models (e.g., RNNs, LSTMs, BERT, Autoencoders) or Generative models (e.g., GANS).

Alternatively, ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks or auto-encoders) to generate solution elements (such as website building system elements and media objects)—possibly as “extensions” to existing site elements.

It will be appreciated that for most embodiments, the ML models may undergo a training or learning phase before they are released into a production or runtime phase or may begin operation with models from existing systems or models. During a training or learning phase, the ML models may be tuned to focus on specific variables, to reduce error margins, or to otherwise optimize their performance. The ML models may initially receive input from a wide variety of data, such as gathered data described herein.

In another embodiment and when appropriate for the particular task, one or more of the ML models may be implemented with rule-based systems, such as an expert system or a hybrid intelligent system that incorporates multiple artificial intelligence (AI) techniques. These are discussed in the articles in the Wikipedia articles entitled “Rule-Based System” and “Hybrid Intelligent System”, at en.wikipedia.com.

Foreign WBS site analyzer 8224 may analyze websites built using a foreign website building system, i.e., a WBS other than the one with which the evaluation engine is integrated. For example, foreign WBS site analyzer 8224 may analyze the component architecture of site produced by a foreign WBS in order to capture underlying definitions and not just the rendered HTML.

BE element analyzer 8225 may analyze back-end elements such as server-side database configuration parameters as (for example) part of a readiness evaluation.

Code analyzer 8226 may analyze any code embedded in the website for purposes such as security, performance, QA, vertical integration, etc. The code could be (for example) embedded in front end or the back end parts of the site (as described in U.S. Pat. No. 10,209,966). This could also include code specific to the WBS or code provided through generalized frameworks (e.g., for a WBS's which allow inclusion of server-side or client-side code or script language).

Vertical application analyzer 8227 may check if the integration or use of vertical applications has been properly performed (e.g., full activation, secure integration, completeness of application programming interface (API) use, etc.).

TPA/WCA 8228 analyzer may analyze any interfaces with associated third party applications and any associated WBS configurable applications to determine setup, configurations, parameters used, security sessions and API version information.

User profile analyzer 8229 may analyze user profile parameters to provide analyzed/processed user information for rule engine 821 for use by any evaluation engines 82 which depend on user parameters. An example would be a rule checking site compliance with Ally (accessibility) regulations specific to a given geography. Checking such a rule may require access both to the site design/layout and to the geo information of the site's designer (and possibly end users).

BI analyzer 8230 may analyze any related business information/intelligence for the site for use by rule engine 821 and EH analyzer 8231 may analyze the stored editing history of the site designer for use by rule engine 821.

Results analyzer 823 may collate the output from the elements of evaluation analyzer 822 and recommender 824 and may provide feedback or recommendations to site modifier 84 according to the output for either automatic or manual updates by the user. Recommender 824 may also issue descriptions which may be used in reporting and corrective action definitions, e.g. options for resolution and further information helping in the correction or improvement of the detected issues as described herein above in relation to site modifier 84. Such definitions can include specific hooks to a specific corrective user interface (UI) of WBS 2 created by UI creator 853 as described in more detail herein below.

Site modifier 84 may apply recommendations directly (by directly modifying the site as stored in CMS 50). Alternatively, site modifier may apply recommendations to the site structure for later resolution (such as adding annotations or indicators). Site modifier may also present special UI modules to a user to manually make changes according to recommendations via site editor 841 as discussed in more detail herein below.

As discussed herein above, evaluation engines 82 may be developed using evaluation engine handler 85 which may provide a development framework for the creation and editing of evaluation engines 82 and the associated rules, scripts and models driving them. Evaluation engine handler 85 may also allow the construction of editing of rules using a specific UI that can access the various data sources. As discussed herein above multiple categories of users may access system 200 to create evaluation engines 82, and these users may have different roles and privileges. Thus, EVE creator 851 may provide different data sources for evaluation based on the user's role and permission. EVE creator 851 may also provide specific APIs for integration with the data sources, the WBS editing platform and other WBS elements.

It will be appreciated that evaluation engines 82 are often defined and set up by the WBS 2 vendor and his staff. However, by using system 200, the user or designer (of the various types as described herein above) can also define their own rules. Thus, rule creation may be focused on simplicity, and allowing the creation of rules while minimizing required user input.

In addition to explicit/manual construction of evaluation engines 82, system 200 may also detect and suggest possible rules (which may be accepted, modified and approved by the user), e.g., by training an ML model based on existing sites and training information either explicitly provided or inferred based on site metrics (such as popularity) as described herein above in relation to ML model trainer 8223.

Such rules may be based on the analysis of multiple sites created (for example) by a single design agency serving multiple clients. Multiple site integrator 8232 may review these multiple sites created by the agency to detect common style and design elements across the sites, possibly generating evaluation engines to inform the agency staff when a created site does not conform to the conventions used in previous sites. Evaluation engine handler 85 may also be used to create the opposite type of rules, diversification rules, which help to make a site different from other sites previously created by the same agency. Such rules may also detect consistency and diversity issues within a specific site (e.g., checking if a given page is consistent with other pages serving similar functionality in the same site).

It will be appreciated that the same method may also be used in different cases or over a different cross-section of sites, e.g., detecting common elements in a given geography or industry type.

The WBS vendor may also deploy evaluation engines 82 to provide baseline recommendations for “best of breed”. Thus, the knowledge of “what is the best way to do sites of type X in WBS Y” may be encoded and applied to multiple user sites.

It will be appreciated that system 200 may automatically create an evaluation engine 82 using specific, specialized rule execution evaluation engines 82 which may handle a specific analysis rule or situation specified using parameterized rules.

Evaluation engines 82 may also be specified using script segments that may be executed to evaluate the collected information. The script language may be a specialized language, a standard language (such as JavaScript), or an extended version of a standard language extended to include interfaces to the gathered information. They also may be specified using one or more ML engines with associated ML models which process the gathered information as described herein above.

It will be appreciated that even though evaluation engines 82 may function as a set of background engines, they may also include evaluation engine user interfaces (UI) defined via UI creator 853. In an alternative embodiment, UI creator may be integrated with WBS editor 30. As discussed herein above, EVE editor 852 may provide a UI allowing a user to edit and update evaluation engines 82.

UI creator 853 may provide a UI for EVE editor 852 which allows a user to provide specific input and parameters to a particular evaluation engine 82. For example, evaluation engine 82 may detect a certain configuration of site elements and request additional information from the user.

Another example would be generated results and recommendations from recommender 824. In particular, the recommendation may include suggested changes to the website's components, content, design, layout, parameters and other elements which may require user input. Site UI creator 842 may also provide a UI include support for corrective actions (e.g., a corrective action wizard) for site editor 841.

It will be appreciated that all of these UI's may be static or may be dynamically generated by UI creator 853 and site UI creator 842 according to the various evaluation 82 engine parameters, web site parameters, and results as discussed in U.S. Pat. No. 10,459,699 entitled “System and Method for the Generation of an Adaptive User Interface in a Website Building System” granted 29 Oct. 2019, commonly owned by the Applicant and incorporated herein by reference. In this scenario, UI creator 853 and site UI creator 842 may create a UI according to components slated for modification instead of a user selected set of components. As discussed in U.S. Pat. No. 10,459,699, interface snippets from the various evaluation engines may also be displayed together with the dynamically adjusted interface.

As discussed herein above, site editor 841 and its UIs created by site UI creator 842 may also be integrated with the WBS editor 30. Site editor 841 may also comprise a results correction UI to function as a site navigation tool integrated with WBS editor 30. Thus, the added UI may help the user review and amend the right components (including affecting resolution, visibility (e.g., display priority), zooming, panning and component selection).

The added UI may also scroll in page to show the relevant components, show the page in multiple resolutions or perform other page transformation (to help the user in editing).

It will be appreciated that site UI creator 842 may also create a transformed or summarized version of the reviewed site or specific parts thereof (such as pages or page sections). Such a transformed version of the site may include, for example, a subset of the components or elements to be modified, allowing the user to browse a smaller part of the site rather than “jumping around” an entire large site. This can be viewed as dynamically creating a “summary site” which demonstrates the relevant site issues, and can be edited by site editor 841 or WBS editor 30 as described herein above. The changes made to the summary site would then in turn be propagated to the full-scale site (including possibly propagating a single change to multiple occurrences in the full-scale site).

Site modifier 84 may automatically integrate any results and recommendations from recommender 824 into the underlying data structure of system 200. It will be appreciated that any recommendation from recommender 824 may be flagged as to its implementation either as a suggestion for a manual update as discussed herein above or automatically by site modifier 84. Site modifier 84 may modify the evaluated site such as by adding components, adding attributes or markers to existing components or adding information layers as described herein above. Site modifier 84 may also interact directly with CMS 50 to handle recommendations that are applicable to WBS data structures. and insert recommendations or associations into the site element structure. This way, recommendations are available for implementation when the site is transformed. For example, if a recommendation is associated with an element X, even if it is not applied immediately, it would remain associated with element X even if element X is moved to another container or page. Notably, a single site may contain multiple such modification sets based on the execution of different evaluation engines 82, or based on multiple rounds of running (e.g., when not all issues flagged by a previous round have been resolved).

In an alternative embodiment, site modifier 84 may also be integrated with EVE editor 852 or WBS editor 30 (or other site management UI) so that the designer can manually make changes to the site based on recommender 824. Examples of such recommendations may be to add an additional layer of information to the edited site, to add added information to existing components (e.g., information which can be reviewed or invoked using extra handles or other added UI) or to modify the displayed site (such as adding components). Automatic UI modification is discussed herein above.

In an alternative embodiment, system 200 may also provide an EVE marketplace (as either part of object marketplace 15 or separately). This would allow evaluation engine authors to distribute them to other users, while preserving their know-how or design.

Thus, all types of users of website building systems may develop and use evaluation engines to evaluate multiple application areas to help them ensure that the website they are developing is of a high quality and meets any requirements.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

Embodiments of the present invention may include apparatus for performing the operations herein. This apparatus may be specially constructed for the desired purposes, or it may comprise a computing device or system typically having at least one processor and at least one memory, selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus. The computer readable storage medium may also be implemented in cloud storage.

Some general purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1-20. (canceled)

21. A website building system (WBS), the system comprising:
at least one hardware processor; and
a site evaluator running on said at least one hardware processor, said site evaluator comprising:
an evaluation engine configured to evaluate a website and identify one or more elements of said website requiring modification;
a site modifier comprising a site UI creator configured to generate a transformed version of a website, said transformed version comprising a subset of said one or more elements identified by said evaluation engine as requiring said modification; and
wherein said site modifier is further configured to receive at least one manual modification from a user of said WBS to said subset of said one or more elements within said transformed version and to propagate said at least one manual modification to said website.

22. The system according to claim 21, wherein said site evaluator also comprises:
an evaluation engine coordinator to receive an evaluation request;
a data gatherer to gather data for use by said evaluation engine; and
a repository to store at least said evaluation engine and its parameters.

23. The system according to claim 22, wherein said evaluation engine comprises:
a rule engine to activate one or more rules stored in said repository;
an evaluation analyzer to evaluate at least one application area according to said rule engine;
a results analyzer to analyze output of said evaluation analyzer; and
a recommender to recommend manual and automatic modifications to said website according to said results analyzer.

24. The system according to claim 23, wherein said evaluation analyzer comprises at least one of:
a WBS object analyzer to analyze component architecture of said website;
an HTML site analyzer to analyze structure and layout of said website; and
a user profile analyzer to determine at least one user category associated with said website.

25. The system according to claim 22, wherein said data gatherer comprises:
a WBS data gatherer to gather information about said website from within said WBS;
an internal data gatherer to integrate information from other sources external to said website within said WBS; and
an external data gatherer to access and integrate information for said website from sources external to said WBS.

26. The system according to claim 23, wherein said at least one application area is at least one of: quality, accessibility, correctness, SEO, compliance, or performance.

27. The system according to claim 24, wherein said site evaluator is configured to evaluate said website according to at least one user category.

28. The system according to claim 27, wherein said at least one user category is at least one of: WBS vendor staff, an accessibility (Ally) reviewer, an agency handling client sites, or a WBS designer.

29. The system according to claim 21, wherein said site modifier is further configured to add annotations or indicators to said one or more elements on said website to identify which of said one or more elements require modification.

30. The system according to claim 21, wherein said site modifier comprises propagates a single change made to an element of said subset to multiple occurrences of said element within said website.

31. A method for a website building system (WBS), the method comprising:
evaluating, a website to identify one or more elements of said website requiring modification;
generating a transformed version of said website, said transformed version comprising a subset of said one or more elements identified as requiring said modification;
receiving at least one manual modification from a user to said subset of said one or more elements within said transformed version; and
propagating said at least one manual modification to said website.

32. The method according to claim 31, further comprising:
receiving an evaluation request prior to said evaluating of said website;
gathering data for use in said evaluating of said website; and
storing information defining said evaluating of said website in a repository.

33. The method according to claim 32, wherein said evaluating said website comprises:
activating one or more rules stored in said repository;
evaluating at least one application area of said website according to said one or more rules; analyzing an output from said evaluating of said at least one application area; and
recommending said at least one manual modification based on said analyzing of said output.

34. The method according to claim 33, wherein said evaluating said at least one application area comprises at least two of:
analyzing the component architecture of said website;
analyzing the structure and layout of said website; and
determining at least one user category associated with said website.

35. The method according to claim 32, wherein said gathering data comprises:
gathering information about said website from within said WBS;
integrating information from other sources external to said website; and
accessing information for said website from sources external to said WBS.

36. The method according to claim 33, wherein said at least one application area is at least one of: quality, accessibility, correctness, SEO, compliance, or performance.

37. The method according to claim 34, wherein said evaluating said website is performed according to said determined at least one user category.

38. The method according to claim 37, wherein said at least one user category is at least one of: WBS vendor staff, an accessibility (Ally) reviewer, an agency handling client sites, or a WBS designer.

39. The method according to claim 31, further comprising: adding annotations or indicators to said one or more elements on said website to identify which of said one or more elements require said modification.

40. The method according to claim 31, wherein said propagating said at least one manual modification comprises propagating a single change made to an element of said subset to multiple occurrences of said element within said website.
